(19) United States
(12) Patent Application Publication
(10) Pub. No.: US 2026/0325395 A1
(43) Pub. Date: Oct. 22, 2026

(54) Structure of massager with upper and lower traveling wheels provided with curtains capable of being synchronously retracted and extended to support human body

(71) Applicant: Lingwei Zhou, Hangzhou (CN)

(72) Inventor: Donghe Wu, Hangzhou (CN)

(21) Appl. No.: 19/719,909

(22) Filed: Jun. 25, 2026

(30) Foreign Application Priority Data
Jun. 26, 2025 (TW) 114124560

(51) Int. Cl. A61H 15/00

(52) U.S. Cl. CPC A61H 15/0078; A61H 2015/0028; A61H 2201/0149; A61H 2201/1215; A61H 2201/149; A61H 2201/1666; A61H 2203/0425

(57) ABSTRACT

A structure of a massager with upper and lower traveling wheels provided with curtains capable of being synchronously retracted and extended to support a human body includes a massage base and a massager. The massage base has a frame. The frame has a left frame body, a right frame body, a front frame body, and a rear frame body. A frame opening is formed among the left frame body, the right frame body, the front frame body, and the rear frame body. Each of the left frame body and the right frame body is recessed with a track and is provided with a tooth rack. A rotating shaft is pivoted on each of a front side and a rear side of the massager. The massager is provided with a motor for rotating a rotating shaft.

### TECHNICAL FIELD

The present invention relates to a structure of a massager with upper and lower traveling wheels provided with curtains capable of being synchronously retracted and extended to support a human body, and in particular, to a structure of a massager with upper and lower traveling wheels provided with curtains capable of being synchronously retracted and extended to support a human body, which can provide more supports for a user.

### BACKGROUND

According to a known massager structure, such as Patent No. I860128 of China, it can be clearly seen that a chair frame of a massage chair is provided with a guide rail, so that a massager can move along the guide rail to massage the entire back of a user. However, it is evident that apart from a movement path of the massager, the chair frame of the massage chair is entirely hollowed out. This design has a problem that the user may sink into a hollowed region because of no support on the chair frame of the massage chair. As a result, a seating positions on the massage chair is not fixed, and the massager applies a non-uniform force and is restricted.

Therefore, in view of this, in conjunction with the idea of the invention, by relying on years of experiences, through extensive discussion, prototype testing, and multiple revisions and improvements, the inventor finally proposes the present invention.

### SUMMARY

A technical problem to be solved in the present invention is to provide a structure of a massager with upper and lower traveling wheels provided with curtains capable of being synchronously retracted and extended to support a human body, to overcome the foregoing drawbacks in the prior art.

Technical features for solving the problem are as follows:

The present invention provides a structure of a massager with upper and lower traveling wheels provided with curtains capable of being synchronously retracted and extended to support a human body, including a massage base and a massager. The massage base has a frame for accommodating the massager to travel up and down. The frame has a left frame body and a right frame body. Front surfaces and rear surfaces of the left frame body and the right frame body are respectively combined with a front frame body and a rear frame body. A frame opening is formed among the left frame body, the right frame body, the front frame body, and the rear frame body. Each of the left frame body and the right frame body is recessed with a track and is provided with a tooth rack. A front side and a rear side of the massager are respectively pivoted with a first rotating shaft and a second rotating shaft. The massager is provided with a motor for rotating the first rotating shaft. A first gear meshed with a corresponding one of the tooth racks is arranged on each of a left side and a right side of the first rotating shaft. Each of the left side and the right side of the first rotating shaft is pivoted with a first guide block clamped into a corresponding one of the two tracks. A lower connecting rod is pivoted between the two first guide blocks. A lower curtain gear meshed with a corresponding one of the first gears is arranged on each of a left side and a right side of the lower connecting rod. A second gear meshed with a corresponding one of the tooth racks is arranged on each of a left side and a right side of the second rotating shaft. A second guide block clamped into a corresponding one of the two tracks is pivoted to each of the left side and the right side of the second rotating shaft. An upper connecting rod is pivoted between the two second guide blocks. An upper curtain gear meshed with a corresponding one of the second gears is arranged on each of a left side and a right side of the upper connecting rod. The massager is provided with at least one massage element for massaging a human body. The front frame body is fixed with a non-elastic lower curtain rolled on the lower connecting rod, and the rear frame body is fixed with a non-elastic upper curtain rolled on the upper connecting rod, so that the lower curtain and the upper curtain hide a large part of the frame opening. After the motor rotates the first rotating shaft, the first gears and the second gears move along the tooth racks. The first gears and the second gears respectively drive the lower curtain gears and the upper curtain gears to rotate the lower connecting rod and the upper connecting rod, to respectively roll or unroll the lower curtain and the upper curtain.

In another embodiment, a difference is that a front side and a rear side of the massager are respectively pivoted with a first rotating shaft and a second rotating shaft. The massager is provided with a motor for rotating the first rotating shaft. A first gear meshed with a corresponding one of the tooth racks is arranged on each of a left side and a right side of the first rotating shaft. Each of the left side and the right side of the first rotating shaft is provided with a first guide block clamped into a corresponding one of the two tracks. Each of a left side and a right side of a front surface of the massager is connected and convexly provided with a first convex portion. The two first convex portions are pivoted with a lower connecting rod. A lower curtain gear meshed with a corresponding one of the first gears is arranged on each of a left side and a right side of the lower connecting rod. A second guide block clamped into a corresponding one of the two tracks is arranged on each of a left side and a right side of the second rotating shaft. Each of a left side and a right side of a rear surface of the massager is connected and convexly provided with a second convex portion. The two second convex portions are pivoted with an upper connecting rod. An upper curtain gear meshed with a corresponding one of the second gears is arranged on each of a left side and a right side of the upper connecting rod. The massager is provided with at least one massage element for massaging a human body.

In different implementation, the massager is provided with a motor for rotating the second rotating shaft. After the motor rotates the second rotating shaft, the first gears and the second gears move along the tooth racks.

A primary objective of the present invention is that in addition to the massager, the lower curtain and the upper curtain hide a large part of the frame opening, so that when a user sits on the massage base, the user can be supported by the lower curtain and the upper curtain and will not sink into the frame opening.

Moreover, the lower connecting rod and the upper connecting rod respectively synchronously roll or unroll the lower curtain and the upper curtain, so that when the massager moves, the lower curtain and the upper curtain keep hiding a large part of the frame opening and stabilize the movement of the massager.

Other objectives, advantages, and novel features of the present invention will become more apparent from the detailed description and accompanying drawings below.

### BRIEF DESCRIPTION OF THE DRAWINGS

FIG. 1 is a three-dimensional diagram of the present invention.

FIG. 2 is an exploded diagram of the present invention.

FIG. 3 is a partial view of the present invention.

FIG. 4 is a side cross-sectional view of the present invention.

FIG. 5 is a cross-sectional view of a gear portion of the present invention.

FIG. 6 is a cross-sectional view of a connecting rod portion of the present invention.

FIG. 7 is a schematic diagram of a massager in a moving state according to the present invention.

FIG. 8 is a cross-sectional view of a gear portion of a massager in a moving state according to the present invention.

FIG. 9 is a cross-sectional view of a connecting rod portion of a massager in a moving state according to the present invention.

FIG. 10 is a schematic diagram of a massager after movement according to the present invention.

FIG. 11 is a schematic diagram of a curtain provided with supporting bars according to the present invention.

FIG. 12 is a three-dimensional diagram of a massager according to another embodiment of the present invention.

FIG. 13 is a schematic diagram of a usage state according to another embodiment of the present invention.

### DETAILED DESCRIPTION OF THE EMBODIMENTS

To enable the esteemed review committee to gain a deeper understanding of the objectives, features, and effects of the present invention, the following details are hereby provided in conjunction with the descriptions of the accompanying drawings as follows:

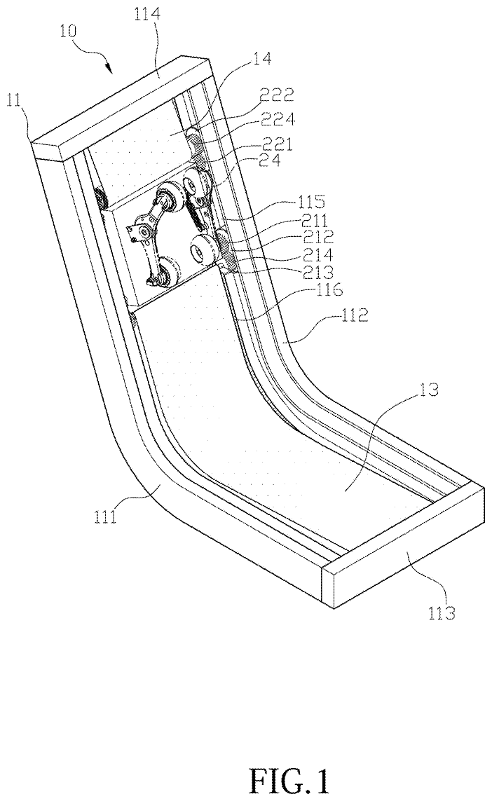

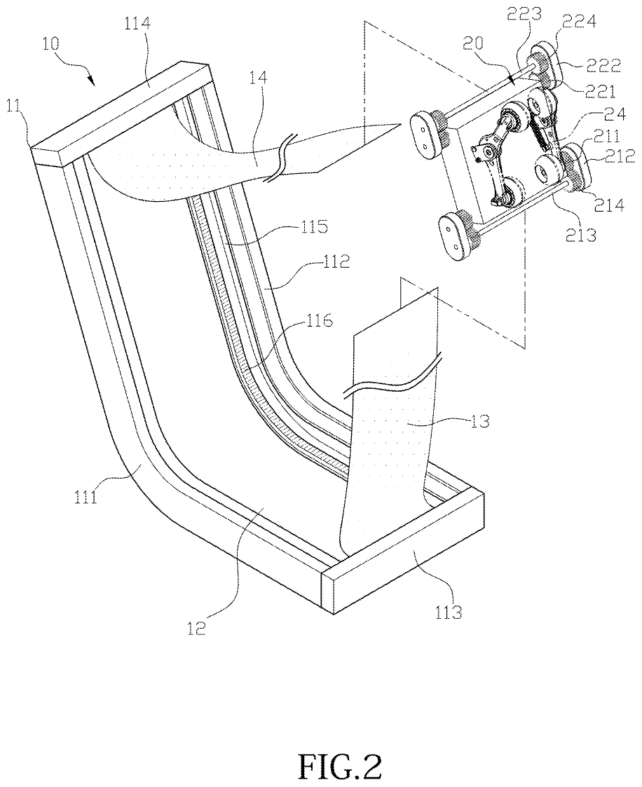

Referring to FIG. 1 to FIG. 2, the present invention provides a structure of a massager with upper and lower traveling wheels provided with curtains capable of being synchronously retracted and extended to support a human body, including a massage base (10) and a massager (20). The massage base (10) has a frame (11) for accommodating the massager (20) to travel up and down. The frame (11) has a left frame body (111) and a right frame body (112). Front surfaces and rear surfaces of the left frame body (111) and the right frame body (112) are respectively combined with a front frame body (113) and a rear frame body (114). A frame opening (12) is formed among the left frame body (111), the right frame body (112), the front frame body (113), and the rear frame body (114). Each of the left frame body (111) and the right frame body (112) is recessed with a track (115) and is provided with a tooth rack (116).

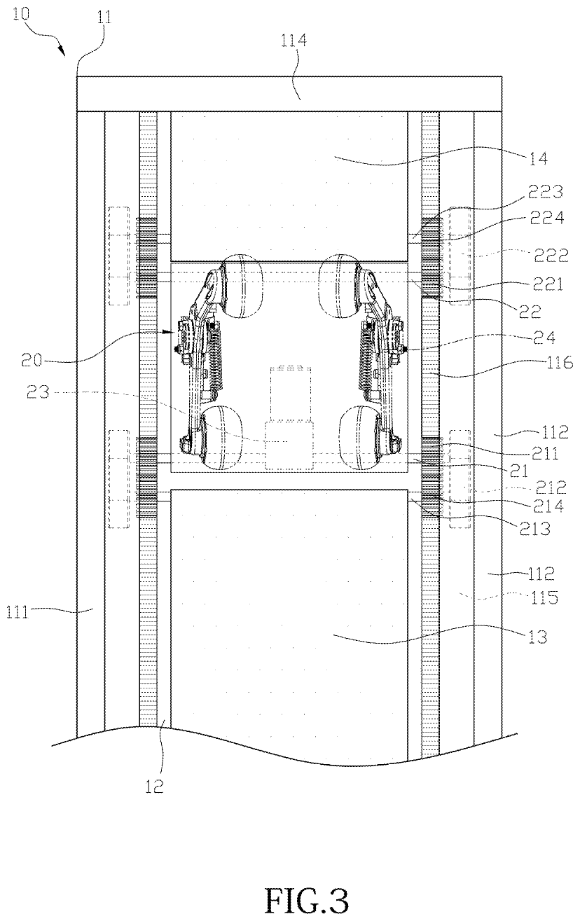

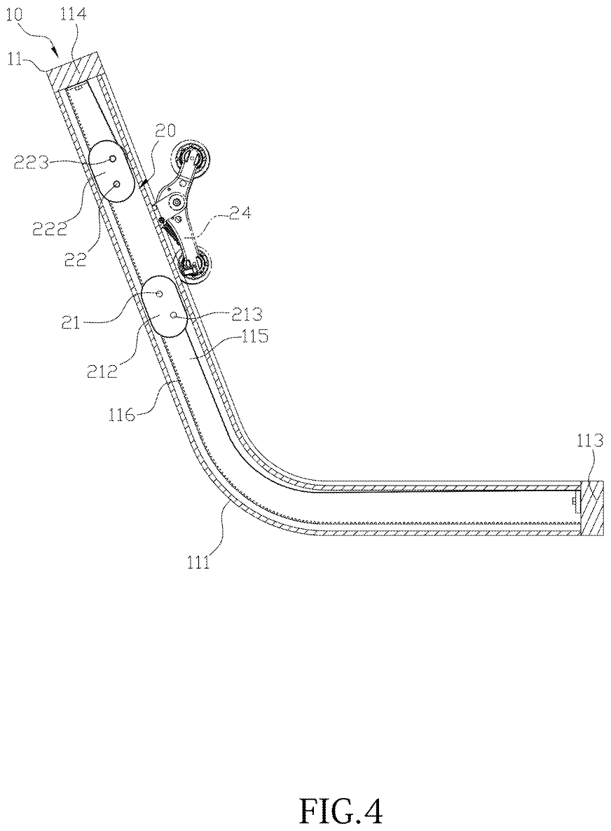

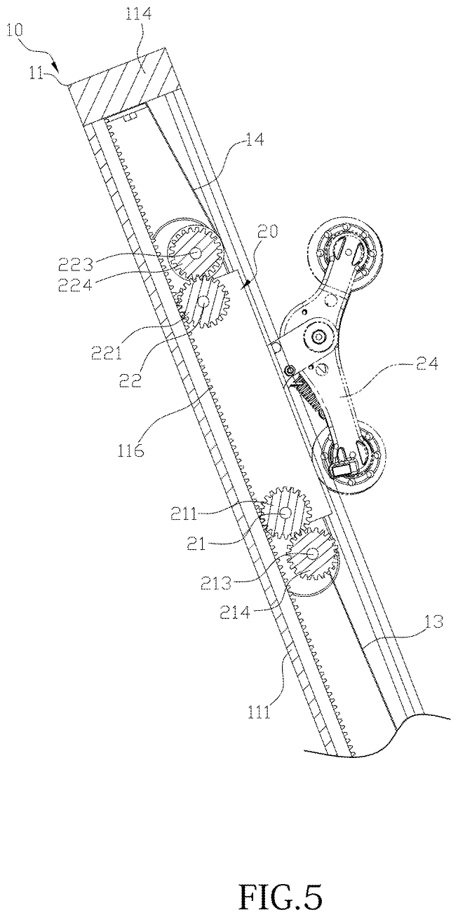

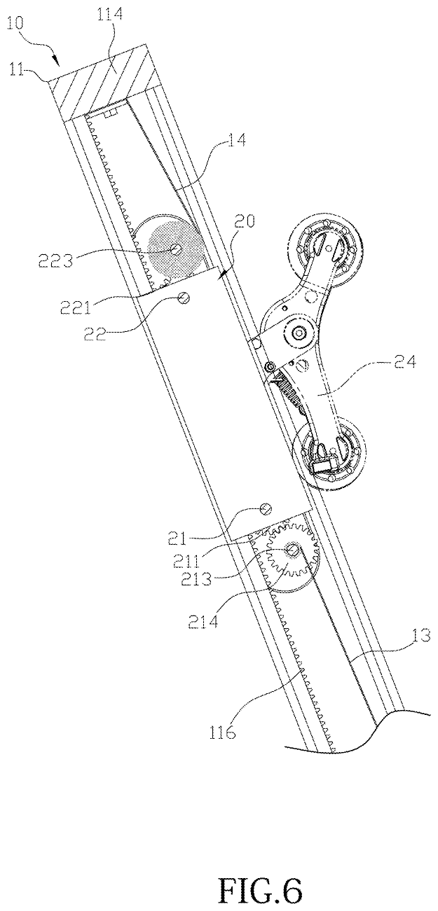

Referring to FIG. 3 to FIG. 6, a front side and a rear side of the massager (20) are respectively pivoted with a first rotating shaft (21) and a second rotating shaft (22). The massager (20) is provided with a motor (23) for rotating the first rotating shaft (21). A first gear (211) meshed with a corresponding one of the tooth racks (116) is arranged on each of a left side and a right side of the first rotating shaft (21). Each of the left side and the right side of the first rotating shaft (21) is pivoted with a first guide block (212) clamped into a corresponding one of the two tracks (115). A lower connecting rod (213) is pivoted between the two first guide blocks (212). A lower curtain gear (214) meshed with a corresponding one of the first gears (211) is arranged on each of a left side and a right side of the lower connecting rod (213). A second gear (221) meshed with a corresponding one of the tooth racks (116) is arranged on each of a left side and a right side of the second rotating shaft (22). A second guide block (222) clamped into a corresponding one of the two tracks (115) is pivoted to each of the left side and the right side of the second rotating shaft (22). An upper connecting rod (223) is pivoted between the two second guide blocks (222). An upper curtain gear (224) meshed with a corresponding one of the second gears (221) is arranged on each of a left side and a right side of the upper connecting rod (223). The massager (20) is provided with at least one massage element (24) for massaging a human body.

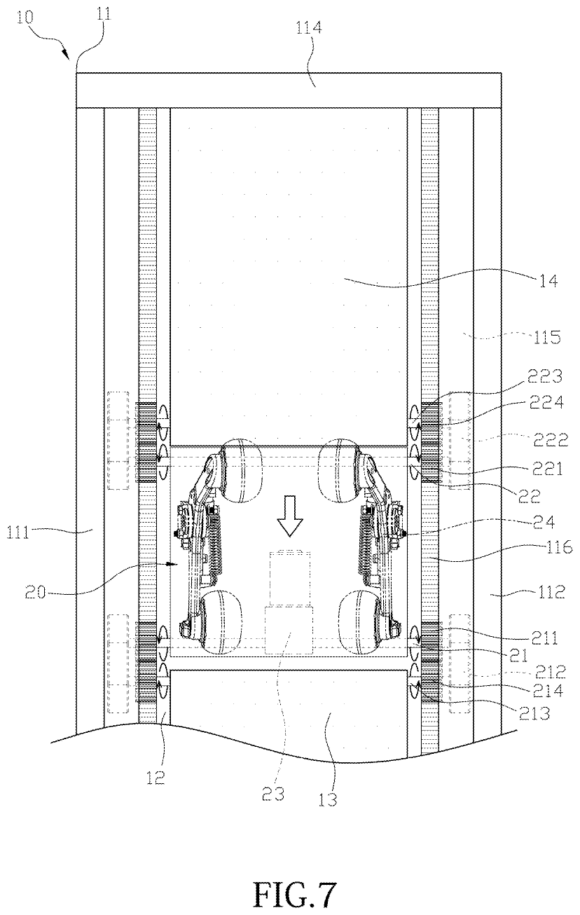

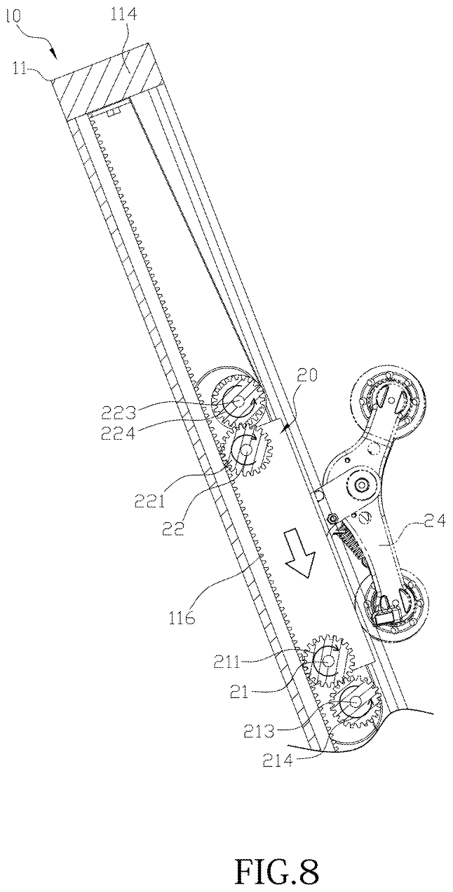

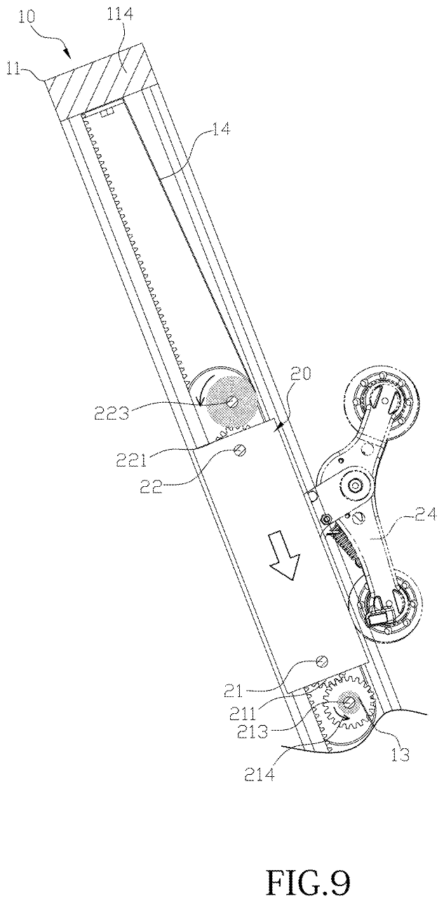

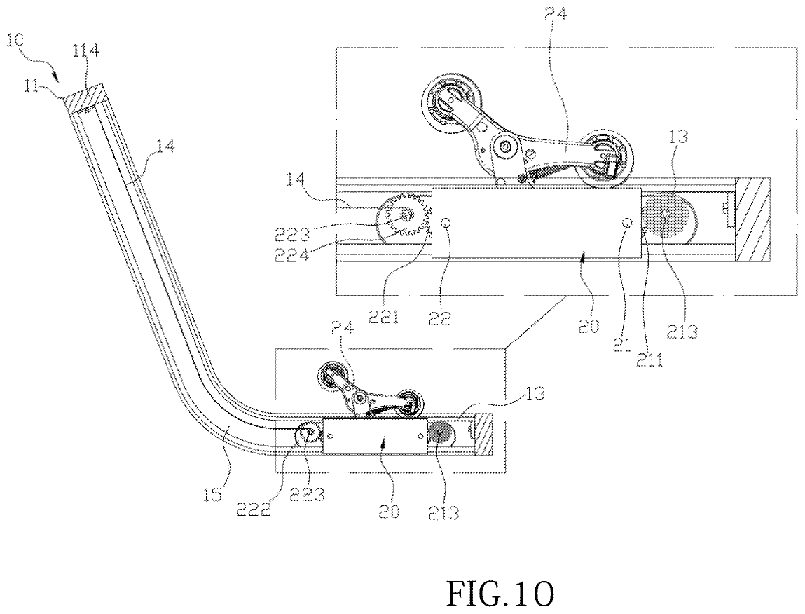

Referring to FIG. 7 to FIG. 10, the front frame body (113) is fixed with a non-elastic lower curtain (13) rolled on the lower connecting rod (213), and the rear frame body (114) is fixed with a non-elastic upper curtain (14) rolled on the upper connecting rod (223), so that the lower curtain (13) and the upper curtain (14) hide a large part of the frame opening. After the motor (23) rotates the first rotating shaft (21), the first gears (211) and the second gears (221) move along the tooth racks (116). The first gears (211) and the second gears (221) respectively drive the lower curtain gears (214) and the upper curtain gears (224) to rotate the lower connecting rod (213) and the upper connecting rod (223), to respectively roll or unroll the lower curtain (13) and the upper curtain (14).

Due to the foregoing structure, in addition to the massager (20), the lower curtain (13) and the upper curtain (14) hide a large part of the frame opening (12), so that when a user sits on the massage base (10), the user can be supported by the lower curtain (13) and the upper curtain (14) and will not sink into the frame opening (12). Moreover, the lower connecting rod (213) and the upper connecting rod (223) respectively synchronously roll or unroll the lower curtain (13) and the upper curtain (14), so that when the massager (20) moves, the lower curtain (13) and the upper curtain (14) keep hiding a large part of the frame opening (12) and stabilize the movement of the massager (20).

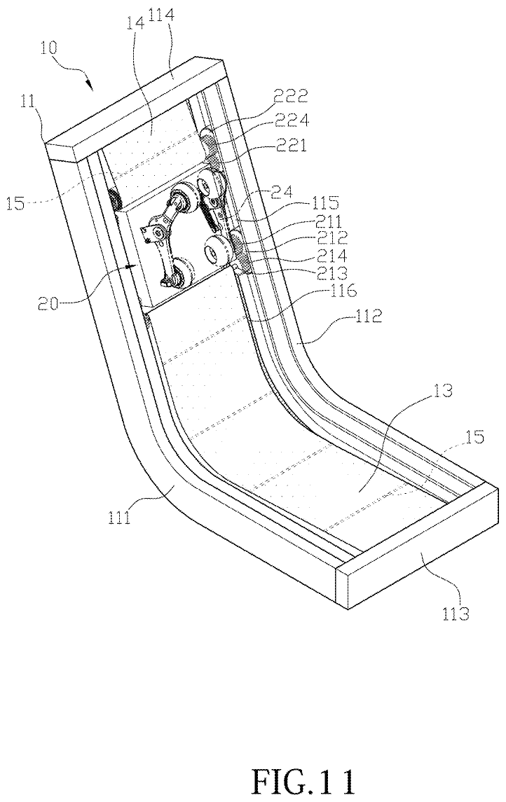

Referring to FIG. 11, according to the structure of the massager with the upper and lower traveling wheels provided with the curtains capable of being synchronously retracted and extended to support the human body, a plurality of hard supporting bars (15) are arranged inside both the lower curtain (13) and the upper curtain (14) to enhance supporting strength.

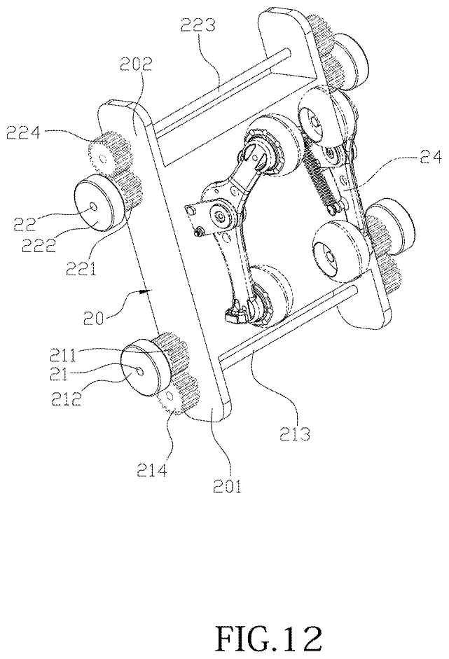

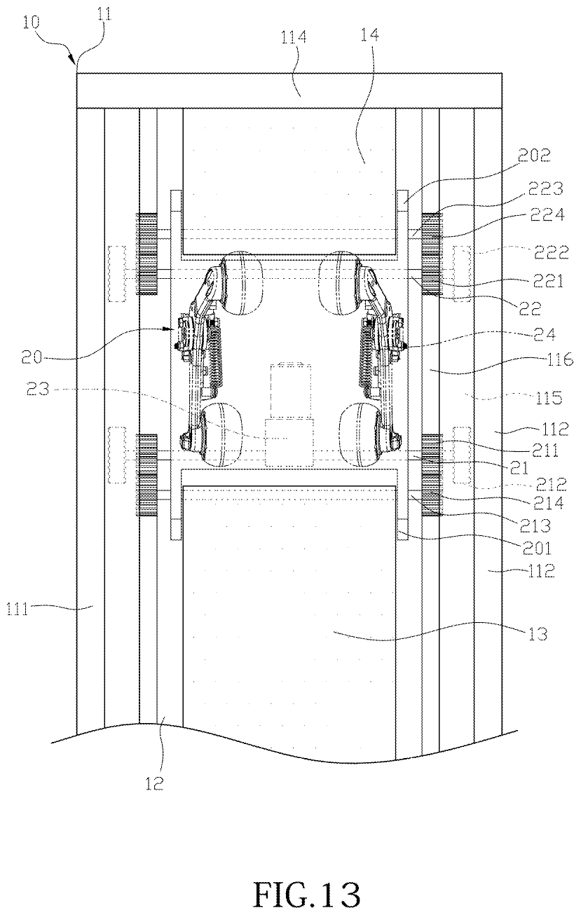

Referring to FIG. 12 to FIG. 13, in another embodiment of the present invention, a difference is that a front side and a rear side of the massager (20) are respectively pivoted with a first rotating shaft (21) and a second rotating shaft (22). The massager (20) is provided with a motor (23) for rotating the first rotating shaft (21). A first gear (211) meshed with a corresponding one of the tooth racks (116) is arranged on each of a left side and a right side of the first rotating shaft (21). Each of the left side and the right side of the first rotating shaft (21) is provided with a first guide block (212) clamped into a corresponding one of the two tracks (115). Each of a left side and a right side of a front surface of the massager (20) is connected and convexly provided with a first convex portion (201). The two first convex portions (201) are pivoted with a lower connecting rod (213). A lower curtain gear (214) meshed with a corresponding one of the first gears (211) is arranged on each of a left side and a right side of the lower connecting rod (213). A second guide block (222) clamped into a corresponding one of the two tracks (115) is arranged on each of a left side and a right side of the second rotating shaft (22). Each of a left side and a right side of a rear surface of the massager (20) is connected and convexly provided with a second convex portion (202). The two second convex portions (202) are pivoted with an upper connecting rod (223). An upper curtain gear (224) meshed with a corresponding one of the second gears (221) is arranged on each of a left side and a right side of the upper connecting rod (223). The massager (20) is provided with at least one massage element (24) for massaging a human body.

In another implementation, the massager (20) is provided with a motor (23) for rotating the second rotating shaft (22). After the motor (23) rotates the second rotating shaft (22), the first gears (211) and the second gears (221) move along the tooth racks (116).

According to the structure of the massager with the upper and lower traveling wheels provided with the curtains capable of being synchronously retracted and extended to support the human body, provided in the present invention, materials of the lower curtain (13) and the upper curtain (14) are canvas.

According to the structure of the massager with the upper and lower traveling wheels provided with the curtains capable of being synchronously retracted and extended to support the human body, provided in the present invention, materials of the lower curtain (13) and the upper curtain (14) are oxford cloth.

According to the structure of the massager with the upper and lower traveling wheels provided with the curtains capable of being synchronously retracted and extended to support the human body, provided in the present invention, materials of the lower curtain (13) and the upper curtain (14) are nylon cloth.

According to the structure of the massager with the upper and lower traveling wheels provided with the curtains capable of being synchronously retracted and extended to support the human body, provided in the present invention, the massage base (10) can be used as a massage table or a massage chair.

According to the structure of the massager with the upper and lower traveling wheels provided with the curtains capable of being synchronously retracted and extended to support the human body, provided in the present invention, front ends and rear ends of the left frame body (11) and the right frame body (112) are not parallel to each other, and have angles.

The foregoing is merely one preferred embodiment of the present invention and is not intended to limit the scope of the present invention. That is, equivalent changes and modifications that are made in accordance with the scope of the claims of the present invention shall all still fall within the patent coverage of the present invention.

### DESCRIPTION OF NUMERALS

The present invention:
10: massage base;
11: frame;
111: left frame body;
112: right frame body;
113: front frame body;
114: rear frame body;
115: track;
116: tooth rack;
12: frame opening;
13: lower curtain;
14: upper curtain;
15: supporting bar;
20: massager;
201: first convex portion;
202: second convex portion;
21: first rotating shaft;
211: first gear;
212: first guide block;
213: lower connecting rod;
214: lower curtain gear;
22: second rotating shaft;
221: second gear;
222: second guide block;
223: upper connecting rod;
224: upper curtain gear;
23: motor; and
24: massage element.

What is claimed is:

1. A structure of a massager with upper and lower traveling wheels provided with curtains capable of being synchronously retracted and extended to support a human body, comprising a massage base and a massager, wherein
the massage base has a frame for accommodating the massager to travel up and down; the frame has a left frame body and a right frame body; front surfaces and rear surfaces of the left frame body and the right frame body are respectively combined with a front frame body and a rear frame body; a frame opening is formed among the left frame body, the right frame body, the front frame body, and the rear frame body; each of the left frame body and the right frame body is recessed with a track and is provided with a tooth rack;
a front side and a rear side of the massager are respectively pivoted with a first rotating shaft and a second rotating shaft; the massager is provided with a motor for rotating the first rotating shaft; a first gear meshed with a corresponding one of the tooth racks is arranged on each of a left side and a right side of the first rotating shaft; each of the left side and the right side of the first rotating shaft is pivoted with a first guide block clamped into a corresponding one of the two tracks; a lower connecting rod is pivoted between the two first guide blocks; a lower curtain gear meshed with a corresponding one of the first gears is arranged on each of a left side and a right side of the lower connecting rod; a second gear meshed with a corresponding one of the tooth racks is arranged on each of a left side and a right side of the second rotating shaft; a second guide block clamped into a corresponding one of the two tracks is pivoted to each of the left side and the right side of the second rotating shaft; an upper connecting rod is pivoted between the two second guide blocks; an upper curtain gear meshed with a corresponding one of the second gears is arranged on each of a left side and a right side of the upper connecting rod; the massager is provided with at least one massage element for massaging a human body;
the front frame body is fixed with a non-elastic lower curtain rolled on the lower connecting rod, and the rear frame body is fixed with a non-elastic upper curtain rolled on the upper connecting rod, so that the lower curtain and the upper curtain hide a large part of the frame opening; after the motor rotates the first rotating shaft, the first gears and the second gears move along the tooth racks; and the first gears and the second gears respectively drive the lower curtain gears and the upper curtain gears to rotate the lower connecting rod and the upper connecting rod, to respectively roll or unroll the lower curtain and the upper curtain.

2. A structure of a massager with upper and lower traveling wheels provided with curtains capable of being synchronously retracted and extended to support a human body, comprising a massage base and a massager, wherein
the massage base has a frame for accommodating the massager to travel up and down; the frame has a left frame body and a right frame body; front surfaces and rear surfaces of the left frame body and the right frame body are respectively combined with a front frame body and a rear frame body; a frame opening is formed among the left frame body, the right frame body, the front frame body, and the rear frame body; each of the left frame body and the right frame body is recessed with a track and is provided with a tooth rack;
a front side and a rear side of the massager are respectively pivoted with a first rotating shaft and a second rotating shaft; the massager is provided with a motor for rotating the second rotating shaft; a first gear meshed with a corresponding one of the tooth racks is arranged on each of a left side and a right side of the first rotating shaft; each of the left side and the right side of the first rotating shaft is pivoted with a first guide block clamped into a corresponding one of the two tracks; a lower connecting rod is pivoted between the two first guide blocks; a lower curtain gear meshed with a corresponding one of the first gears is arranged on each of a left side and a right side of the lower connecting rod; a second gear meshed with a corresponding one of the tooth racks is arranged on each of a left side and a right side of the second rotating shaft; a second guide block clamped into a corresponding one of the two tracks is pivoted to each of the left side and the right side of the second rotating shaft; an upper connecting rod is pivoted between the two second guide blocks; an upper curtain gear meshed with a corresponding one of the second gears is arranged on each of a left side and a right side of the upper connecting rod; the massager is provided with at least one massage element for massaging a human body;
the front frame body is fixed with a non-elastic lower curtain rolled on the lower connecting rod, and the rear frame body is fixed with a non-elastic upper curtain rolled on the upper connecting rod, so that the lower curtain and the upper curtain hide a large part of the frame opening; after the motor rotates the second rotating shaft, the first gears and the second gears move along the tooth racks; and the first gears and the second gears respectively drive the lower curtain gears and the upper curtain gears to rotate the lower connecting rod and the upper connecting rod, to respectively roll or unroll the lower curtain and the upper curtain.

3. A structure of a massager with upper and lower traveling wheels provided with curtains capable of being synchronously retracted and extended to support a human body, comprising a massage base and a massager, wherein
the massage base has a frame for accommodating the massager to travel up and down; the frame has a left frame body and a right frame body; front surfaces and rear surfaces of the left frame body and the right frame body are respectively combined with a front frame body and a rear frame body; a frame opening is formed among the left frame body, the right frame body, the front frame body, and the rear frame body; each of the left frame body and the right frame body is recessed with a track and is provided with a tooth rack;
a front side and a rear side of the massager are respectively pivoted with a first rotating shaft and a second rotating shaft; the massager is provided with a motor for rotating the first rotating shaft; a first gear meshed with a corresponding one of the tooth racks is arranged on each of a left side and a right side of the first rotating shaft; each of the left side and the right side of the first rotating shaft is provided with a first guide block clamped into a corresponding one of the two tracks; each of a left side and a right side of a front surface of the massager is connected and convexly provided with a first convex portion; the two first convex portions are pivoted with a lower connecting rod; a lower curtain gear meshed with a corresponding one of the first gears is arranged on each of a left side and a right side of the lower connecting rod; a second guide block clamped into a corresponding one of the two tracks is arranged on each of a left side and a right side of the second rotating shaft; each of a left side and a right side of a rear surface of the massager is connected and convexly provided with a second convex portion; the two second convex portions are pivoted with an upper connecting rod; an upper curtain gear meshed with a corresponding one of the second gears is arranged on each of a left side and a right side of the upper connecting rod; the massager is provided with at least one massage element for massaging a human body;
the front frame body is fixed with a non-elastic lower curtain rolled on the lower connecting rod, and the rear frame body is fixed with a non-elastic upper curtain rolled on the upper connecting rod, so that the lower curtain and the upper curtain hide a large part of the frame opening; after the motor rotates the first rotating shaft, the first gears and the second gears move along the tooth racks; and the first gears and the second gears respectively drive the lower curtain gears and the upper curtain gears to rotate the lower connecting rod and the upper connecting rod, to respectively roll or unroll the lower curtain and the upper curtain.

4. A structure of a massager with upper and lower traveling wheels provided with curtains capable of being synchronously retracted and extended to support a human body, comprising a massage base and a massager, wherein
the massage base has a frame for accommodating the massager to travel up and down; the frame has a left frame body and a right frame body; front surfaces and rear surfaces of the left frame body and the right frame body are respectively combined with a front frame body and a rear frame body; a frame opening is formed among the left frame body, the right frame body, the front frame body, and the rear frame body; each of the left frame body and the right frame body is recessed with a track and is provided with a tooth rack;
a front side and a rear side of the massager are respectively pivoted with a first rotating shaft and a second rotating shaft; the massager is provided with a motor for rotating the second rotating shaft; a first gear meshed with a corresponding one of the tooth racks is arranged on each of a left side and a right side of the first rotating shaft; each of the left side and the right side of the first rotating shaft is provided with a first guide block clamped into a corresponding one of the two tracks; each of a left side and a right side of a front surface of the massager is connected and convexly provided with a first convex portion; the two first convex portions are pivoted with a lower connecting rod; a lower curtain gear meshed with a corresponding one of the first gears is arranged on each of a left side and a right side of the lower connecting rod; a second guide block clamped into a corresponding one of the two tracks is arranged on each of a left side and a right side of the second rotating shaft; each of a left side and a right side of a rear surface of the massager is connected and convexly provided with a second convex portion; the two second convex portions are pivoted with an upper connecting rod; an upper curtain gear meshed with a corresponding one of the second gears is arranged on each of a left side and a right side of the upper connecting rod; the massager is provided with at least one massage element for massaging a human body;
the front frame body is fixed with a non-elastic lower curtain rolled on the lower connecting rod, and the rear frame body is fixed with a non-elastic upper curtain rolled on the upper connecting rod, so that the lower curtain and the upper curtain hide a large part of the frame opening; after the motor rotates the second rotating shaft, the first gears and the second gears move along the tooth racks; and the first gears and the second gears respectively drive the lower curtain gears and the upper curtain gears to rotate the lower connecting rod and the upper connecting rod, to respectively roll or unroll the lower curtain and the upper curtain.

5. The structure of the massager with the upper and lower traveling wheels provided with the curtains capable of being synchronously retracted and extended to support the human body according to claim 1, wherein a plurality of hard supporting bars are arranged inside both the lower curtain and the upper curtain to enhance supporting strength.

6. The structure of the massager with the upper and lower traveling wheels provided with the curtains capable of being synchronously retracted and extended to support the human body according to claim 1, wherein materials of the lower curtain and the upper curtain are canvas.

7. The structure of the massager with the upper and lower traveling wheels provided with the curtains capable of being synchronously retracted and extended to support the human body according to claim 1, wherein materials of the lower curtain and the upper curtain are oxford cloth.

8. The structure of the massager with the upper and lower traveling wheels provided with the curtains capable of being synchronously retracted and extended to support the human body according to claim 1, wherein materials of the lower curtain and the upper curtain are nylon cloth.

9. The structure of the massager with the upper and lower traveling wheels provided with the curtains capable of being synchronously retracted and extended to support the human body according to claim 1, wherein the massage base can be used as a massage table or a massage chair.

10. The structure of the massager with the upper and lower traveling wheels provided with the curtains capable of being synchronously retracted and extended to support the human body according to claim 1, wherein front ends and rear ends of the left frame body and the right frame body are not parallel to each other, and have angles.
